(19) United States
(12) Patent Application Publication
(10) Pub. No.: US 2024/0242254 A1
(43) Pub. Date: Jul. 18, 2024

(54) SYSTEM AND METHOD FOR PROVIDING CONVERGED UTILITIES BILLING

(71) Applicant: RAKUTEN SYMPHONY SINGAPORE PTE. LTD., Singapore (SG)

(72) Inventor: Viswanathan VENKATARAMAN, Indore (IN)

(73) Assignee: RAKUTEN SYMPHONY SINGAPORE PTE. LTD., Singapore (SG)

(21) Appl. No.: 18/008,511

(22) PCT Filed: Aug. 31, 2022
(86) PCT No.: PCT/US2022/042141

§ 371 Date: Mar. 7, 2024

(51) Int. Cl. G06Q 30/04; G06Q 30/015; G16Y 10/35

(52) U.S. Cl. CPC G06Q 30/04; G06Q 30/015; G16Y 10/35

(57) ABSTRACT

A system for providing converged utilities billing includes a customer relationship management (CRM) module configured to receive information from utilities providers for providing different types of utilities to a customer based on respective utilities plans, the CRM module comprising a database configured to store information associated with the customer; a product catalogue configured to store plan information regarding at least one utilities plan in association with each of the utilities providers; a data collection module configured to receive raw data from a plurality of Internet of Things (IoT) sensors and to process the raw data to form processed data; and a utilities rating and billing module configured to receive the processed data and the information associated with the customer, and to generate a single invoice for the customer based on the received processed data and on the received information.

### FIELD

Apparatuses and methods consistent with example embodiments of the present disclosure relate to a converged utilities billing to a customer of plural utility providers from which the customer receive services.

### BACKGROUND

In a related art utility billing system, a utility customer selects and purchases a utility plan from a utility provider. The utility provider measures the customer's usage of the utility (e.g., water, electric, gas, and the like) and bills the customer based on the measured usage.

In this case, a customer of more than one utility provider receives a separate bill from each individual utility provider. The receipt of many bills may be inconvenient for the customer.

For example, separate utility providers may send bills on different dates, and the payment due date may be different for each of the bills. It may be burdensome for the customer to keep track of and manage multiple utility bills with different payment due dates. It may also be inconvenient for the customer to monitor and manage utility expenses because each bill payment is made separately.

In a related art system, the utility provisioning system is separate and independent from the utility billing system. In this case, the bill received by the customer may be inconsistent with the services actually provided to the customer because of a communication failure between the utility billing system and the utility provisioning system.

### SUMMARY

According to embodiments, systems and methods are provided for providing utilities billing. Systems and methods are provided for a customer of more than one separate and independent utility provider to receive a single bill including the billings of all utility providers from which the customer receives service.

A converged utilities billing system may include a centralized inventory and order management module that is accessible by utility providers. The centralized inventory and order management module is communicatively connected both to a utility rating and billing module and to a utility provisioning system. Each of the utility providers controls the provided utility service using a single system.

A converged utilities billing system may include a data collection module that continuously collects and processes data from a plurality of utility measuring devices. The utility measuring devices may be Internet of Things (IOT) sensors that continuously provide data to the data collection module.

A converged utilities billing system may provide a single monthly bill to a customer from multiple utility providers. The single monthly bill may be convenient for the customer and may facilitate on-time bill payment and utilities expense management by the customer. The converged utilities billing system may include both of a billing system and a provisioning system to improve consistency between the bill received by the customer and the services actually provided to the customer.

In accordance with an aspect of the disclosure, a system for providing integrated utilities billing includes an order management module configured to receive information from utilities providers for providing different types of utilities to at least one customer based on respective utilities plans, the order management module including a database configured to store information associated with the at least one customer; a product catalogue configured to store plan information regarding at least one utilities plan in association with each of the utilities providers; a data collection module configured to receive raw data from a plurality of Internet of Things (IoT) sensors and to process the raw data to form processed data; and a utilities rating and billing module configured to receive the processed data from the data processing module and the information associated with the at least one customer from the order management module, and to generate a single invoice for the at least one customer based on the received processed data and on the received information, wherein the generated single invoice comprises an invoice for each of the utilities providers providing utilities to the at least one customer.

In accordance with an aspect of the disclosure, a method for providing information regarding one or more utilities plans stored in a product catalogue includes receiving information from utilities providers for providing different types of utilities to at least one customer based on respective utilities plans, wherein the information associated with the at least one customer includes a mobile directory number (MDN) of the at least one customer selecting a utilities plan from a utilities provider from among the utilities providers; determining whether the MDN of the at least one customer matches an MDN of customer information previously stored in a database; and providing the information regarding the one or more utilities plans to the utilities provider based on the determination.

### BRIEF DESCRIPTION OF THE DRAWINGS

Features, advantages, and significance of example embodiments of the disclosure will be described below with reference to the accompanying drawings, in which like signs denote like elements, and wherein:

FIG. 1 illustrates a system for providing utilities billing according to an embodiment;

FIG. 2 is a block diagram of a customer relationship management (CRM) module according to an embodiment;

FIG. 3 is a block diagram of a data collection module 120 according to an embodiment;

FIG. 4 is a flowchart of a method of processing a service order for a utility service in a converged utility billing system according to an embodiment;

FIG. 5A illustrates examples of User Profiles generated by a CRM module according to an example embodiment, and FIG. 5B illustrates examples of Service Profiles generated by a product catalogue module according to an example embodiment;

FIG. 6 is a flowchart of a method of generating a single invoice for a customer including billing information for each of plural utility providers associated with the customer, according to an embodiment;

FIG. 7 is a diagram of an example environment in which systems and/or methods, described herein, may be implemented; and

FIG. 8 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

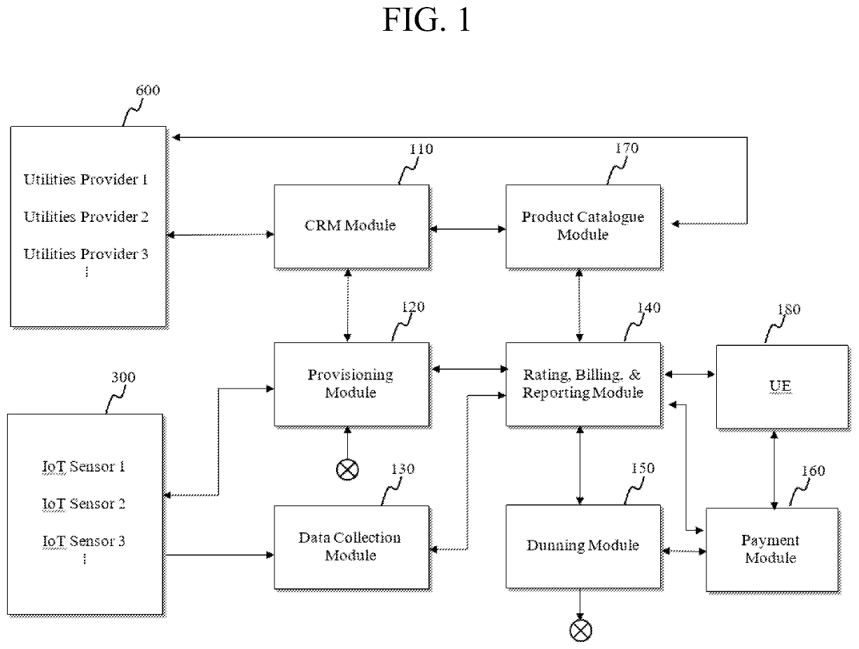

FIG. 1 illustrates a block diagram of a system for providing utilities billing according to an embodiment. Referring to FIG. 1, according to an embodiment, a system for providing utilities billing includes a customer relationship management (CRM) module 110, a provisioning module 120, a data collection module 130, a rating, billing and reporting module (RBR) 140, a dunning module 150, a payment module 160, and a product catalogue module 170.

The CRM module 110 is a centralized inventory and order management module accessible by a plurality of utilities providers 600 (e.g., gas, water, electricity, etc.) via, by way of example, a portal gateway. In an embodiment, the CRM module 110 may also communicate with customers (user equipment (UE) 180 in FIG. 1) via the portal gateway or a different portal. Further, the CRM module 110 is coupled to the provisioning module 120 and the rating, billing and reporting (RBR) module 140 such that the plurality of utilities providers 600 are able to control (e.g., active, terminate, etc.) their services via a single system.

The CRM module 110 may be configured to receive and maintain (e.g., in a database or storage) customer information from the plurality of utilities providers 600 (e.g., gas, water, electricity, etc.). At least some of the utilities providers 600 may, although not necessarily, be of the same company. The customers may, for example, be existing or prospective customers of one or more utilities providers 600. According to another embodiment, the CRM module 110 may receive the customer information directly from the customer (i.e., from the UE 180). The customer information may be maintained as user profiles in a storage of the CRM module 110. Additionally, the CRM module 110 may manage service orders from customers for services (or service plans) provided by the utilities providers, maintain an inventory of sensors for assignment, and assign the sensors based on the service orders, as will be described in further detail below.

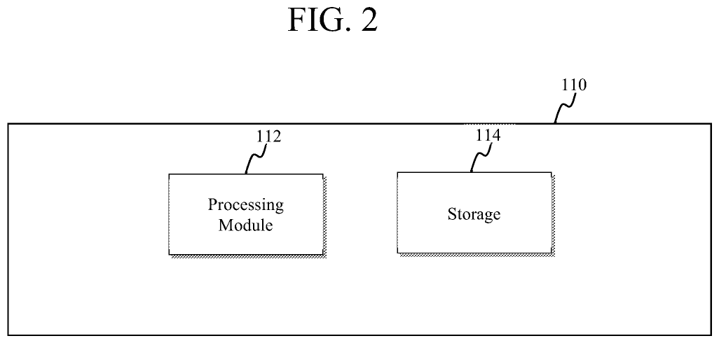

FIG. 2 is a block diagram of the CRM module 110 according to an embodiment. Referring to FIG. 2, the CRM module 110 may include a processing module 112 (e.g., at least one processor) and a storage 114 (i.e., at least one storage).

The processing module 112 is configured to receive customer information from the plurality of utilities providers 600. For example, a customer (or user) may approach a utility provider to subscribe to or purchase a utility service. In this case, the utility provider collects the customer's information and provides the same to the processing module 112. Here, the customer information may include, for example, at least one of a customer identification (ID) (or user ID), the customer's name, the customer's mobile number or mobile directory number (MDN), the customer's e-mail address, the customer's address, customer's preferences with respect to service plans (e.g., cost-saving/economical, most reliable, etc.), etc.

For each customer information that is received, the processing module 112 is configured to determine whether a User Profile exists for the customer (i.e., whether a User Profile corresponding to the customer is stored in the storage 114) based on the received customer information. Each customer registered in the system has a User Profile generated and managed by the CRM module 110 (i.e., generated by the processing module 112 and stored in the storage 114). The User Profile includes comprehensive user information of the corresponding user (i.e., customer), such as the received customer information of the user, subscribed or purchased service plans (if any) of the user, sensors (if any) assigned or provisioned for the user in association with the subscribed or purchased plans, etc. To determine whether a User Profile exists for a customer, the processing module 112 may query the storage 114 (e.g., database of User Profiles included in the storage 114) using at least one item of the customer information (e.g., user ID, name, number, and/or e-mail address) as a primary key. If the User Profile does not exist for the customer (i.e., has not previously been generated and stored in the storage 114), the processing module 112 generates a User Profile of the customer. If the User Profile does exist for the customer, the processing module 112 may determine whether there are any differences between the received customer information and the information included in the User Profile, and may update the User Profile accordingly (i.e., using the newest information from the received customer information).

Furthermore, the processing module 112 is configured to receive service orders from customers based on at least one of Service Profiles stored in and provided by the product catalogue module 170 and User Profiles stored in the storage 114. The Service Profiles include, for each of different services (e.g., electric, water, gas, etc.), at least one of information on service plans provided by at least one utility provider for the corresponding service, fees for those plans, geographic areas of coverage for those plans, etc.

Referring back to the previous example in which a customer (or user) approaches a utility provider to subscribe to or purchase a utility service, the processing module 112 receives the customer information of the customer (as described above), generates or obtains a User Profile of the customer (as described above), and obtains a Service Profile corresponding to a service type (e.g., electric, water, gas, etc.) of the utility provider from the product catalogue module 170. Here, the processing module 112 may obtain the Service Profile by sending, to the product catalogue module 170, a request including an identifier of the service type of the utility provider from which the customer information is received. The processing module 112 may then determine, from the Service Profile, which service plans are available to offer to the customer and/or which service plan(s) to recommend to the customer. The processing module 112 may determine the available service plans from among those service plans provided by the utility provider from which the customer information is received, or from among service plans provided by any utility provider for the corresponding service.

In an example embodiment, the processing module 112 may determine which service plan(s) to offer or recommend based on both the User Profile and the Service Profile. For example, the processing module 114 may determine, based on the customer's address (included in the User Profile and/or received customer information), service plans included in the Service Profile that are available for the customer's address. By way of another example, if the User Profile indicates a user preference for the most economic plans, the processing module 112 may determine which of the available service plans are most economical or cost-efficient. Additionally (or alternatively), the processing module 112 may determine existing service plans provided to the customer from the User Profile of the customer, may determine the billing cycles (e.g., monthly, weekly, bi-weekly, etc.) of those service plans from the User Profile or from the Service Profiles corresponding to the service types of the respective service plans, and may then determine the available service plans as those with the same billing cycle.

Subsequently, the processing module 112 outputs the determined service plan(s) for a user (i.e., customer) to select therefrom. Here, the determined service plan(s) may be output in the form of a GUI provided by the CRM module 110 to the user (i.e., UE 180), such that the user makes a selection directly to the CRM module 110 (i.e., via a portal). According to another example embodiment, the determined service plan(s) may be provided to the utility provider from which the customer information is received, such that the user selection is made via the utility provider and then sent therefrom to the CRM module 110 (i.e., via a portal).

Next, the processing module 112 is configured to process service orders from customers (or users). Referring to the previous example, upon receipt of a user's selection of a service plan from among the determined service plan(s), the processing module 112 creates a service order and assigns one or more sensors associated with the service order based on Inventory Information stored in the storage 114. The Inventory Information includes information on a plurality of Internet of Things (IoT) sensors 300 (described in further detail below), such as an identifier of each of the sensors (e.g., ID number), an availability of each of the sensors (i.e., availability to be provisioned or assigned), a type of each of the sensors (e.g., a service type or utility to which the sensor corresponds), etc. The processing module 112 then sends an activation message to the provisioning module 120 to activate the assigned one or more sensors (described in further detail below), and updates the Inventory Information accordingly (e.g., upon successful activation, the Inventory Information may be updated to indicate that the corresponding sensor(s) are not available or are assigned) and/or the User Profile accordingly. In some embodiments, the activation message may include the User Profile of the corresponding user.

The storage 114 (e.g., one or more databases) stores the User Profiles and the Inventory Information. As set forth above, each User Profile includes comprehensive user information of the corresponding user (i.e., customer), such as at least one of the received customer information of the user, subscribed or purchased service plans (if any) of the user, a type or types of services (if any) provided to the user, a utility provider or providers that provide the subscribed or purchased service plans (if any), and information on IoT sensors 300 (if any) assigned or provisioned for the user in association with the subscribed or purchased plans. The customer information may include a mobile directory number (MDN) associated with the customer. The information regarding each of the IoT sensors 300 may include, for example, an IoT sensor ID, an MDN of the IoT sensor 300, an international mobile subscriber identity (IMSI) of the IoT sensor 300, its current status as active or inactive, information related to the activation time of the IoT sensor 300, and the like. The information about the IoT sensors 300 such as the current status, activation time, and the like, may be received, for example, from the provisioning module 120 and/or the data collection module 130 (to be described below).

The Inventory Information, as described above, includes information on the plurality of Internet of Things (IoT) sensors 300, such as an identifier of each of the sensors (e.g., ID number), an availability of each of the sensors (i.e., availability to be provisioned or assigned), a type of each of the sensors (e.g., a service type or utility to which the sensor corresponds), etc. While it is described above that certain information about the IoT sensors 300 (e.g., current status, activation time, etc.) is included in the User Profiles, it is understood that one or more other embodiments are not limited thereto. For example, according to another embodiment, this information regarding the IoT sensors 300 (or at least some of this information) may be additionally or alternatively stored in the Inventory Information.

Referring back to FIG. 1, the provisioning module 120 is configured to activate IoT sensors 300 based on activation messages received from the CRM module 110 (i.e., the processing module 112), and to inform the rating, billing and reporting (RBR) module 140 of the activation such that the RBR module 140 is notified of a time to start recording the service usage and computing the related rating and billing. Here, the provisioning module 120 may send a notification message including the activation status and the User Profile to the RBR module 140. According to another embodiment, the notification message may be sent by the CRM module 110.

In further detail, the provisioning module 120 may activate or deactivate IoT sensors 300 according to activation information or deactivation information (in case a service plan expires or is terminated) received from the CRM module 110. The provisioning module 120 may also receive status information from the IoT sensors 300 according to whether the IoT sensors 300 are activated or deactivated. The provisioning module 130 may transmit the received status information to the CRM module 110 to be stored in association with customer information in the storage 114 (e.g., to be stored in the User Profile as described above).

The data collection module 130 may continuously (or periodically, discontinuously based on event trigger, etc.) collect and process (e.g., normalize, filter, enrich, etc.) usage data (e.g., raw usage data) from a plurality of utility devices (e.g., water meter, electricity meter, etc.), and provide the processed data to the RBR module 140.

Specifically, each of the utility devices includes or is provided with (e.g., by a utility provider) an IoT sensor 300. The IoT sensor 300 may be provided or installed on a utility device upon being provisioned or assigned in accordance with a service order (e.g., by a utility provider, a third party, an operator of the system, etc.), or may be previously included with the utility device (i.e., prior to the service order). The IoT sensors 300 are configured to communicate with the data collection module 130 via wireless communication (e.g., via a radio access network (RAN)) such that usage data can continuously be provided to the data collection module 130 (e.g., via a data platform gateway connected to the RAN). According to another embodiment, the usage data may be provided periodically or in response to a triggering event. The IoT sensors 300 may include one or more Subscriber Identity Module (SIM)-based sensors, e.g., sensors communicatively coupled to one or more SIMs such as a standard SIM (2FF), Micro-SIM (3FF), Nano SIM (4FF), embedded SIM (eSIM), for example, MFF2, and any other suitable types of SIM. The RAN by way of which the usage data (e.g., raw usage data) may be received may include, for example, any one or more of a 2G, 3G, 4G, 5G, or any other suitable telecommunications technology. However, the system is not limited thereto, and may receive the raw data from the IoT sensors 300 by way of any wired or wireless communication.

In some embodiments, the data collection module 130 is also configured to receive device status information (or sensor status information in response to sensor status requests) from the CRM module 110. For example, the data collection module 130 may receive information indicating a device status (activated or deactivated in accordance with the provisioning or order information) from the CRM module 110 (as stored in the storage 112). Based on the device status information, the data collection module 130 may detect an anomaly or unusual behavior (e.g., sensor data continuing to be collected from an IoT sensor that has been deactivated, received data indicating unusual or alarming behavior, etc.), and output an alert to a user (e.g., customer or system administrator) and/or utility provider. In accordance with one or more embodiments, since the usage data is provided from the sensors 300 continuously and the abnormal or unusual event is detected at the data collection module 130 that receives the sensor data in real time or near real time, the alarm may be issued in real time or near real time.

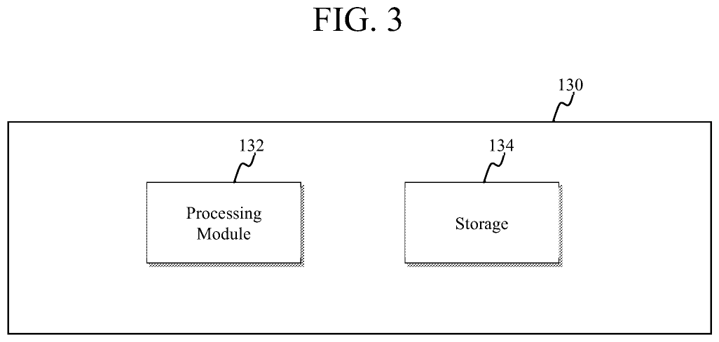

FIG. 3 is a block diagram of a data collection module 130 according to an embodiment. Referring to FIG. 3, the data collection module 130 includes a processing module 132 to process data received from the plurality of IoT sensors 300 and a storage 134 for storing a predetermined set of rules to process raw data.

The data collection module 130 may receive raw data from the plurality of IoT sensors 300 by way of, for example, the RAN and an IoT device gateway (which may be external to the system, included in the system, or included in the data collection module 130). The processing module 132 may then perform processing functions on the raw data such as encoding, decoding, normalization, filtration, enrichment, etc., and may then transmit processed data to the RBR module 140 to be described below.

The received raw data may include a plurality of fields. For example, each IoT sensor 300 of the plurality of IoT sensors 300 may transmit one or more fields of data by way of the RAN to the system (i.e., to the data collection module 130 via the IoT device gateway). The processing module 132 may normalize the raw data by organizing the received raw data according to a predetermined set of rules, stored in the storage 134, to form the processed data. For example, the processing module 132 may filter the received raw data by selectively removing one or more fields from the received raw data to form the processed data. Further, the processing module 132 may enrich the raw data by adding one or more fields to form the processed data. The added one or more fields may be generated by the processing module 132 based on other fields received in the raw data from the IoT sensors 300.

Referring back to FIG. 1, the RBR module 140 is configured to calculate a service rating for each service provided to a customer, and calculate a billing amount for each service provided to the customer. Further, the RBR module 140 is configured to generate a billing invoice for each customer, where said billing invoice includes the billing amount for each service provided to the customer. The billing invoice is generated in accordance with a billing cycle, which may be aligned or the same for each of the provided services as a result of the above-described determination by the processing module 112 of available service plans having a same billing cycle as existing (subscribed/purchased) service plan(s) of the customer when offering new service plans to be selected by the customer. According to another embodiment, the billing cycles may not be controlled to be equivalent for each of the service plans of a customer. For example, if a billing cycle for subscribed service plan A of a customer is monthly and for subscribed service plan B of the customer is bi-monthly, then the RBR module 140 will generate a billing invoice with only the billing amount for service plan A every odd month and will generate a billing invoice with billings amounts for both service plan A and service plan B every even month.

In further detail, as described above, the data collection module 130 provides the processed usage data to the RBR module 140. The RBR module 140 determines, based on IoT sensor information included in the processed data, which User Profile is associated with the processed data. As set forth above, the User Profile information is provided to the RBR module 140 in the notification message from the provisional module 120 (or, in some embodiments, the CRM module 110), and stored by the RBR module 140. According to another embodiment, the RBR module 140 may obtain the User Profile in response to the received usage data. For example, the RBR module 140 may provide IoT sensor information (e.g., sensor ID) included in or with the processed usage data to the CRM module 110 and the CRM module 110 may then lookup and provide the corresponding User Profile to the RBR module 140. Subsequently, by comparing the IoT sensor information including in the processed data and the IoT sensor information included in the User Profile, the RBR module 140 determines the associated service, and obtains the related Service Profile from the product catalogue module 170. Based on fee descriptions included in the Service Profile and the usage information included in the processed data, the RBR module 140 computes and updates a service rating (e.g., kWH/day for electricity, m³/day for water, etc.) and/or a billing amount. The RBR module 140 may provide the service rating and/or the billing amount to a user (customer) via a GUI accessible by the user upon logging into the system. In this regard, the RBR module 140 may receive the processed usage data in real time (e.g., via real time or event data streams, such as Kafka streams) and continuously compute and update the service rating and/or billing amount in real time, such that a user accessing the system via UE 180 to view a usage report can be provided with the latest service usage information and/or billing amount. According to an embodiment, the RBR module 140 may also provide real time usage information and/or billing amounts to a utilities provider 600 (e.g., in response to a request received from the utilities provider 600 or via a GUI accessible by a utility provider upon logging into the system).

The RBR module 140 is configured to generate a billing invoice in accordance with a predetermined billing cycle (e.g., monthly and on the last working day of every month). The billing invoice may be computed based on the service ratings and the fee descriptions indicated by the Service Profile (e.g., for electricity, obtain a total service rating in kWh by summing all daily ratings, and then multiply the total service rating by the fee charge (yen or dollar/kWh) to obtain the monthly electric bill, etc.). Here, it is understood that the RBR module 140 generate the billing invoice to include the billing amount for each service that a user is subscribed to. As a result, the user is provided with a single billing invoice including a billing amount for all of plural utility services that the user is subscribed to.

Upon completing the generation of a billing invoice, the RBR module 140 sends the billing invoice (e.g., monthly invoice) to user equipment (UE) 180 of the user (e.g., via email, short messaging service (SMS), push notifications in a dedicated billing app, etc.). The billing invoice may also be accessible via a portal page of the system that the user may log into. Additionally, the RBR module 140 provides the billing information (e.g., username/ID, outstanding amount, payment due date, information of associated services, etc.) to the dunning module 150. Further, if payment of the billing invoice is received via the payment module 160, the RBR module 140 is notified of such payment from the payment module 160 and may store the payment information and generate and provide an invoice or receipt (e.g., in response to a request from the user/customer). If payment is received after a payment due date, a fine or penalty fee may be charged to the user in accordance with terms of a service plan. In such case, the RBR module 140 receives notification from the payment module 160 of such payment such that the fine or penalty fee will be included by the RBR module 140 in a subsequent billing invoice.

The dunning module 150 is configured to create a dunning plan based on the billing information and one or more predetermined dunning policies or rules (e.g., stored in a storage of the dunning module 150). For example, if a payment due date for a user is August 25, the dunning module 150 will (a) schedule to send a first reminder to the user if the payment has not yet been made by August 18, (b) schedule to send a second reminder to the user if the payment has not yet been made by August 20, (c) schedule to send a final reminder to the user if the payment has not yet been made by August 25, and (d) schedule a service termination if the payment has not yet been made by August 30. The number of deadlines and dates thereof, as well as the corresponding conditions and actions of those deadlines, may be set forth in the predetermined dunning policies or rules. Further, if payment of a billing invoice is received via the payment module 160, the dunning module 150 is notified of such payment from the payment module 160 (or from the RBR module 140) and may delete or cancel the dunning plan (or the remainder of the dunning plan should any actions of the dunning plan have already been performed). If payment of the billing invoice is received after the payment due date (August 25 in the above example) but before the a service termination deadline (August 30 in the above example), the dunning module 150 may receive notification from the payment module 160 of such payment such that a service termination process can be avoided.

Meanwhile, if no payment is received by a service termination deadline, the dunning module 150 may send a service termination request (including the user ID and the service information) to the provisioning module 120. Based on the information included in the service termination request, the provisioning module 120 will deactivate the utility services and the associated IoT sensors. In order to reactivate the service, a user may need to reapply for the service via the utility provider or the CRM module 110, or may pay an amount of fine for late payment and for service re-activation (in which case, the dunning module may re-activate the utility service and the associated IoT sensors in a similar manner).

As set forth above, the payment module 160 is configured to receive payment of billing invoices from users, and notify the RBR module 140 and/or the dunning module 150 accordingly.

Further, as set forth above, the product catalogue module 170 is configured to store a plurality of Service Profiles and provide the same to the CRM module 110 and the RBR module 140. The product catalogue module 170 receives service plan information from each of the plurality of utilities providers 600, and processes and stores the service plan information in the Service Profiles respectively corresponding to the service type of each plan. The received plan information may include at least one of a plan ID, a plan title or name, billing cycle information, fee information, plan discounts and/or offers, geographical area of coverage, etc.

While the above-described example embodiments describe service orders being made via the CRM module 110, it is understood that one or more other example embodiments are not limited thereto. For example, according to another example embodiment, a service order may be placed directly with a utility provider and then provided from the utility provider to the CRM module 110. In this case, the CRM module 110 may still determine the available service plan(s) for a customer and provide the determination result to the utility provider to be offered by the utility provider to the user. As a result, a preferred service plan and/or a service plan that has a same billing cycle as other utility service plans subscribed by a user can be determined and offered, even if the other utility service plans are provided by a different utility provider.

Moreover, while the above-described example embodiments describe the Service Profiles as respectively corresponding to different service types, it is understood that one or more example embodiments are not limited thereto. For example, according to another embodiment, the Service Profiles may be generated and maintained on a per-service provider (as opposed to per-service type) basis.

Related art systems may require a customer, such as a user of different types of utilities from different utilities providers 600, to communicate directly with each one of the provisioning systems of each individual type of provided utility in order to obtain an invoice for utility services. The system in accordance with example embodiments, however, allows a customer of different types of utilities to conveniently acquire a single invoice from different types of utilities providers 600. In particular, the system collects service plan offerings from each of plural utilities providers 600, determines appropriate service plans to offer to a customer based thereon, manages provisioning of sensors centrally for all of the plural utilities providers 600, receives usage data from each of the sensors for the various types of services, and combines billing information for each of the services of a user into a single invoice. Moreover, the system provides user access to real time information on service usage and/or billing by receiving the usage data continuously and processing the data in real time across multiple components (e.g., utilizing real time data or event streams and API calls between various modules or microservices of the various modules).

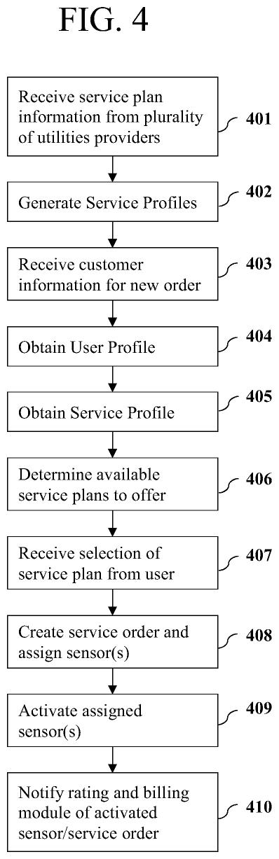

FIG. 4 is a flowchart of a method of processing a service order for a utility service in a converged utility billing system according to an embodiment. The method of FIG. 4 may be performed by the billing system described above with reference to FIGS. 1 through 3.

Referring to FIG. 4, at step 401, utility service plan information is received by the product catalogue module 170 from a plurality of utilities providers 600. Here, the utility service plan information may be provided periodically or in response to an event (e.g., new service plan, update to service plan, etc.). The plan information may include at least one of a plan ID, a plan title or name, billing cycle information, fee information, plan discounts and/or offers, geographical area of coverage, etc. According to an embodiment, the plan information may be submitted by a utility provider through a portal of the system accessible by the utility provider (e.g., a utility provider registered with the system to thereby access a particular workspace or portal of the system upon successful authentication). Alternatively, the plan information may be collected or obtained by an administrator of the system from the utilities providers and submitted thereby to the product catalogue module 170.

At step 402, the product catalogue module 170 categorizes the received plan information on a per-service type basis to generate (or update) Service Profiles. For example, the product catalogue module 170 collects and categorizes the information according to the type of service (e.g., all plan information falling under the same service type will be compiled under the same category), and then creates or updates a corresponding Service Profile accordingly. The Service Profile includes information of the services provided by each utility provider with respect to a corresponding service type. For example, each Service Profile may include all or some of the information included in the received plan information. The Service Profiles are stored in a storage (e.g., a storage of the product catalogue module 170). According to another embodiment, the Service Profiles may be generated on a basis other than service type (e.g., on a utility provider basis, geographic area of coverage basis, etc.), or a combination of plural bases (e.g., service type and geographic area of coverage).

At step 403, the CRM module 110 receives customer information of a prospective customer that desires to subscribe to a utility service plan. Here, the customer information may be submitted to or obtained by a utility provider from a prospective (or current) customer desiring to subscribe to or change a current service plan, and provided from the utility provider to the CRM module 110 (e.g., via a portal gateway). Alternatively, the customer information may be submitted to or obtained by the CRM module 110 directly from the customer. The customer information may include user information (e.g., user's ID, mobile number, address, etc.) and may be submitted with information on a particular service type that the customer desires to subscribe to or update. Alternatively, the service type information may be omitted and may be inferred by the CRM module 110 from the utility provider that provides the customer information (e.g., if the customer information is provided by a gas utility provider, it can be inferred that the desired service type is gas).

At step 404, the CRM module 110 obtains a User Profile of the customer (i.e., user). Specifically, based on the received customer information, the CRM module 110 determines whether a User Profile exists for the customer (i.e., whether a User Profile corresponding to the customer is stored in a storage). As described above, each customer registered in the system has a User Profile generated and managed by the CRM module 110. The User Profile includes comprehensive user information of the corresponding user (i.e., customer), such as the received customer information of the user, subscribed or purchased service plans (if any) of the user, sensors (if any) assigned or provisioned for the user in association with the subscribed or purchased plans, etc. If the User Profile does not exist for the customer (i.e., has not previously been generated and stored in the storage 114), the CRM module 110 generates a User Profile of the customer. If the User Profile does exist for the customer, the CRM module 110 may determine whether there are any differences between the received customer information and the information included in the User Profile, and may update the User Profile accordingly (i.e., using the newest information from the received customer information).

At step 405, the CRM module 110 obtains a Service Profile corresponding to the particular service type desired by the customer, from the product catalogue module 170. Here, the CRM module 110 may obtain the Service Profile by sending, to the product catalogue module 170, a request including an identifier of the service type of the utility provider from which the customer information is received and receiving the corresponding Service Profile in response. It is understood that steps 404 and 405 may be performed in a different order, simultaneously, substantially simultaneously, or with some temporal overlap.

At step 406, the CRM module 110 determines, from the Service Profile, which service plans are available to offer to the customer and/or which service plan(s) to recommend to the customer. The CRM module 110 may determine the available service plans from among those service plans provided by the utility provider from which the customer information is received, or from among service plans provided by any utility provider for the corresponding service. In an example embodiment, the CRM module 110 may determine which service plan(s) to offer or recommend based on both the User Profile and the Service Profile. For example, the CRM module 110 may determine, based on the customer's address (included in the User Profile and/or received customer information), service plans included in the Service Profile that are available for the customer's address. By way of another example, if the User Profile indicates a user preference for the most economic plans, the CRM module 110 may determine which of the available service plans are most economical or cost-efficient. Additionally (or alternatively), the CRM module 110 may determine existing service plans provided to the customer from the User Profile of the customer, may determine the billing cycles (e.g., monthly, weekly, bi-weekly, etc.) of those service plans from the User Profile or from the Service Profiles corresponding to the service types of the respective service plans, and may then determine the available service plans as those with the same billing cycle.

At step 407, the CRM module 110 receives a selection from the customer of a service plan from among the determined service plan(s). For example, the CRM module 110 outputs the determined service plan(s) for a user (i.e., customer) to select therefrom. Here, the determined service plan(s) may be output in the form of a GUI provided by the CRM module 110 to the user (i.e., UE 180), such that the user makes a selection directly to the CRM module 110 (i.e., via a portal). According to another example embodiment, the determined service plan(s) may be provided to the utility provider from which the customer information is received, such that the user selection is made via the utility provider and then sent therefrom to the CRM module 110 (i.e., via a portal).

At step 408, the CRM module 110 creates a service order and assigns one or more sensors associated with the service order based on Inventory Information stored therein. As described above with reference to FIG. 2, the Inventory Information includes information on a plurality of sensors 300 (e.g., IoT sensors), such as an identifier of each of the sensors (e.g., ID number), an availability of each of the sensors (i.e., availability to be provisioned or assigned), a type of each of the sensors (e.g., a service type or utility to which the sensor corresponds), etc.

At step 409, the CRM module 110 sends an activation message to the provisioning module 120 to activate the assigned one or more sensors and updates the Inventory Information accordingly (e.g., upon successful activation, the Inventory Information may be updated to indicate that the corresponding sensor(s) are not available or are assigned) and/or the User Profile accordingly.

At step 410, a notification is sent (e.g., by the provisioning module 120 or the CRM module 110) to the RBR module 140 including user information and sensor information (e.g., included in the User Profile) and activation information indicating activation of the service and/or sensor. As a result, the RBR module 140 can be notified of a time to start recording or expecting service usage information and computing the related rating and billing information for the user.

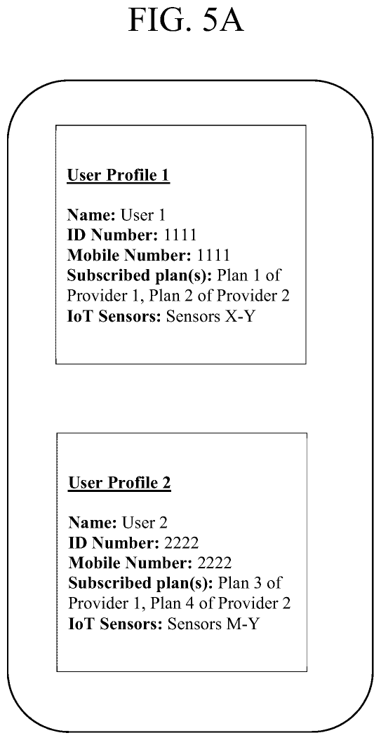

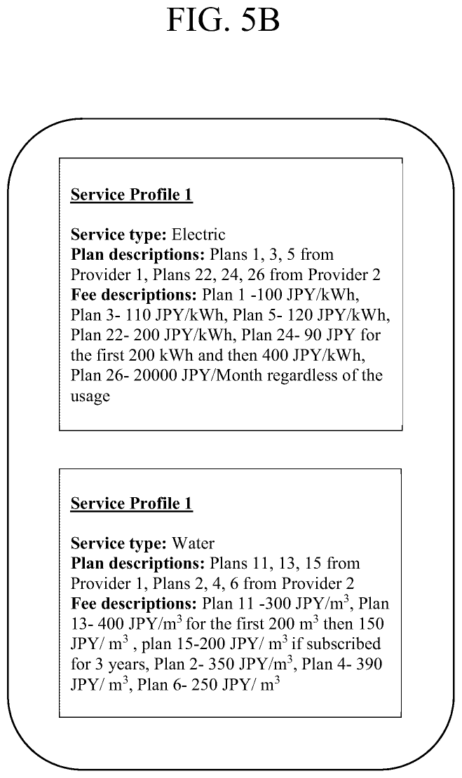

FIG. 5A illustrates examples of User Profiles generated by a CRM module according to an example embodiment, and FIG. 5B illustrates examples of Service Profiles generated by a product catalogue module according to an example embodiment. As shown in FIG. 5A, a first User Profile (User Profile 1) of a first user (User 1) includes information on the first user (name, ID number, mobile number), subscribed plans of the first user (Plan 1 of Provider 1, Plan 2 of Provider 2), and IoT sensors assigned or provisioned to the first user (Sensors X-Y). Similarly, a second User Profile (User Profile 2) of a second user (User 2) includes information on the second user (name, ID number, mobile number), subscribed plans of the second user (Plan 3 of Provider 1, Plan 4 of Provider 2), and IoT sensors assigned or provisioned to the first user (Sensors M-N). It is understood that the User Profile may include additional information (e.g., address of the user, service preferences of the user, etc.).

As shown in FIG. 5B, a first Service Profile (Service Profile 1) corresponding to a first service type (Electric) includes plan descriptions from each provider that provides the service type, and fee descriptions thereof. A second Service Profile (Service Profile 2) corresponding to a second service type (Water) includes plan descriptions from each provider that provides the service type, and fee descriptions thereof. It is understood that the Service Profile may include additional information (e.g., geographic areas of coverage for each plan, etc.).

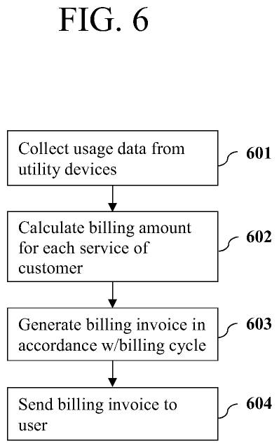

FIG. 6 is a flowchart of a method of generating a single invoice for a customer including billing information for each of plural utility providers associated with the customer, according to an embodiment. The method of FIG. 6 may be performed by the billing system described above with reference to FIGS. 1 through 3.

Referring to FIG. 6, at step 601, the data collection module 130 continuously (or periodically, discontinuously based on event trigger, etc.) receives and processes (e.g., normalize, filter, enrich, etc.) usage data (e.g., raw usage data) from a plurality of utility devices (e.g., water meter, electricity meter, etc.), and provides the processed data to the RBR module 140. Here, the data collection module 130 may receive raw data from the plurality of IoT sensors 300 by way of, for example, the RAN and an IoT device gateway (which may be external to the system, included in the system, or included in the data collection module 130). The data collection module 130 may then perform processing functions on the raw data such as encoding, decoding, normalization, filtration, enrichment, etc., and may then transmit processed data to the RBR module 140 to be described below.

At step 602, the RBR module 140 calculates a service rating for each service provided to a customer, and calculates a billing amount for each service provided to the customer.

In further detail, as described above, the data collection module 130 provides the processed usage data to the RBR module 140. The RBR module 140 determines, based on IoT sensor information included in the processed data, which User Profile is associated with the processed data. Subsequently, by comparing the IoT sensor information including in the processed data and the IoT sensor information included in the User Profile, the RBR module 140 determines the associated service, and obtains the related Service Profile from the product catalogue module 170. Based on fee descriptions included in the Service Profile and the usage information included in the processed data, the RBR module 140 computes and updates a service rating (e.g., kWH/day for electricity, m³/day for water, etc.) and/or a billing amount.

At step 603, the RBR module 140 generates a billing invoice for the customer in accordance with a billing cycle for the customer, where said billing invoice includes the billing amount for each service provided to the customer. The billing invoice is generated in accordance with a billing cycle, which may be aligned or the same for each of the provided services as a result of the above-described determination by the CRM module 110 of available service plans having a same billing cycle as existing (subscribed/purchased) service plan(s) of the customer when offering new service plans to be selected by the customer. The billing invoice may be computed based on the service ratings and the fee descriptions indicated by the Service Profile (e.g., for electricity, obtain a total service rating in kWh by summing all daily ratings, and then multiply the total service rating by the fee charge (yen or dollar/kWh) to obtain the monthly electric bill, etc.). Here, it is understood that the RBR module 140 generate the billing invoice to include the billing amount for each service that a user is subscribed to. As a result, the user is provided with a single billing invoice including a billing amount for all of plural utility services that the user is subscribed to.

At step 604, the RBR module 140 sends the billing invoice (e.g., monthly invoice) to the user (e.g., user equipment (UE) 180 of the user). For example, the billing invoice may be sent via email, short messaging service (SMS), push notifications in a dedicated billing app, a portal screen of the system logged into by the user, etc.

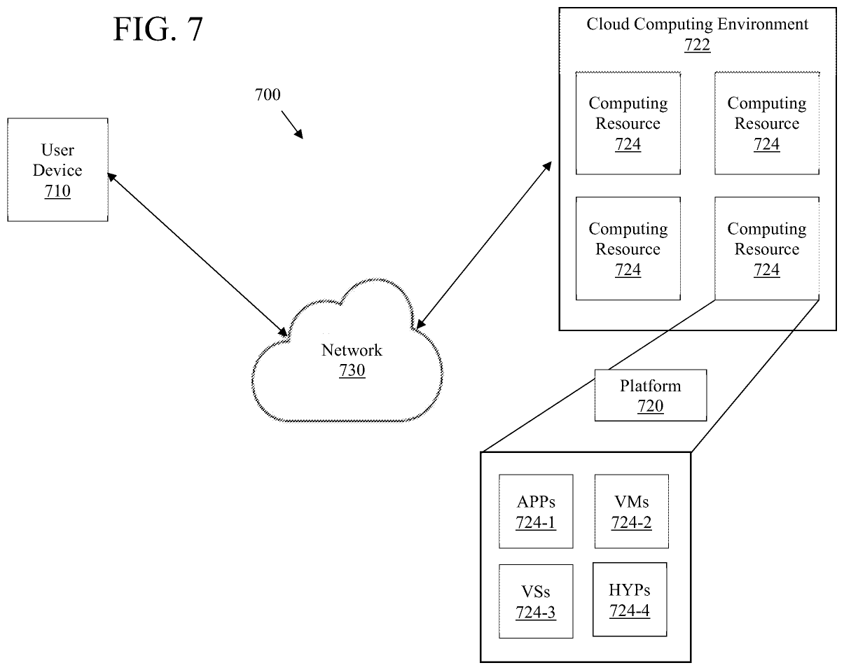

FIG. 7 is a diagram of an example environment 700 in which systems and/or methods, described herein, may be implemented. As shown in FIG. 7, environment 700 may include a user device 710, a platform 720, and a network 730. Devices of environment 700 may interconnect via wired connections, wireless connections, or a combination of wired and wireless connections. In embodiments, any of the functions and operations described with reference to FIG. 1 above may be performed by any combination of elements illustrated in FIG. 7.

User device 710 includes one or more devices capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 710 may receive information from and/or transmit information to platform 720.

Platform 720 includes one or more devices capable of receiving, generating, storing, processing, and/or providing information. In some implementations, platform 720 may include a cloud server or a group of cloud servers. In some implementations, platform 720 may be designed to be modular such that certain software components may be swapped in or out depending on a particular need. As such, platform 720 may be easily and/or quickly reconfigured for different uses.

In some implementations, as shown, platform 720 may be hosted in cloud computing environment 722. Notably, while implementations described herein describe platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts platform 720. Cloud computing environment 722 may provide computation, software, data access, storage, etc., services that do not require end-user (e.g., user device 710) knowledge of a physical location and configuration of system(s) and/or device(s) that hosts platform 720. As shown, cloud computing environment 722 may include a group of computing resources 724 (referred to collectively as “computing resources 724” and individually as “computing resource 724”).

Computing resource 724 includes one or more personal computers, a cluster of computing devices, workstation computers, server devices, or other types of computation and/or communication devices. In some implementations, computing resource 724 may host platform 720. The cloud resources may include compute instances executing in computing resource 724, storage devices provided in computing resource 724, data transfer devices provided by computing resource 724, etc. In some implementations, computing resource 724 may communicate with other computing resources 724 via wired connections, wireless connections, or a combination of wired and wireless connections.

As further shown in FIG. 7, computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

Application 724-1 includes one or more software applications that may be provided to or accessed by user device 710. Application 724-1 may eliminate a need to install and execute the software applications on user device 710. For example, application 724-1 may include software associated with platform 720 and/or any other software capable of being provided via cloud computing environment 722. In some implementations, one application 724-1 may send/receive information to/from one or more other applications 724-1, via virtual machine 724-2.

Virtual machine 724-2 includes a software implementation of a machine (e.g., a computer) that executes programs like a physical machine. Virtual machine 724-2 may be either a system virtual machine or a process virtual machine, depending upon use and degree of correspondence to any real machine by virtual machine 724-2. A system virtual machine may provide a complete system platform that supports execution of a complete operating system (“OS”). A process virtual machine may execute a single program, and may support a single process. In some implementations, virtual machine 724-2 may execute on behalf of a user (e.g., user device 710), and may manage infrastructure of cloud computing environment 722, such as data management, synchronization, or long-duration data transfers.

Virtualized storage 724-3 includes one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. Hypervisor 724-4 may present a virtual operating platform to the guest operating systems, and may manage the execution of the guest operating systems. Multiple instances of a variety of operating systems may share virtualized hardware resources.

Network 730 includes one or more wired and/or wireless networks. For example, network 730 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

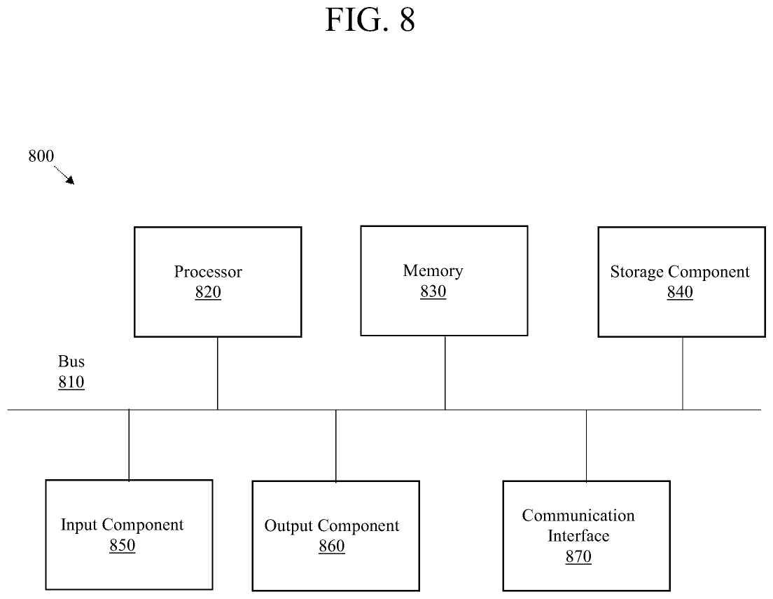

FIG. 8 is a diagram of example components of a device 800. Device 800 may correspond to user device 710 and/or platform 720. As shown in FIG. 8, device 800 may include a bus 810, a processor 820, a memory 830, a storage component 840, an input component 850, an output component 860, and a communication interface 870.

Bus 810 includes a component that permits communication among the components of device 800. Processor 820 may be implemented in hardware, firmware, or a combination of hardware and software. Processor 820 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. Memory 830 includes a random access memory (RAM), a read only memory (ROM), and/or another type of dynamic or static storage device (e.g., a flash memory, a magnetic memory, and/or an optical memory) that stores information and/or instructions for use by processor 820.

Storage component 840 stores information and/or software related to the operation and use of device 800. For example, storage component 840 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 850 includes a component that permits device 800 to receive information, such as via user input (e.g., a touch screen display, a keyboard, a keypad, a mouse, a button, a switch, and/or a microphone). Additionally, or alternatively, input component 850 may include a sensor for sensing information (e.g., a global positioning system (GPS) component, an accelerometer, a gyroscope, and/or an actuator). Output component 860 includes a component that provides output information from device 800 (e.g., a display, a speaker, and/or one or more light-emitting diodes (LEDs)).

Communication interface 870 includes a transceiver-like component (e.g., a transceiver and/or a separate receiver and transmitter) that enables device 800 to communicate with other devices, such as via a wired connection, a wireless connection, or a combination of wired and wireless connections. Communication interface 870 may permit device 800 to receive information from another device and/or provide information to another device. For example, communication interface 870 may include an Ethernet interface, an optical interface, a coaxial interface, an infrared interface, a radio frequency (RF) interface, a universal serial bus (USB) interface, a Wi-Fi interface, a cellular network interface, or the like.

Device 800 may perform one or more processes described herein. Device 800 may perform these processes in response to processor 820 executing software instructions stored by a non-transitory computer-readable medium, such as memory 830 and/or storage component 840. A computer-readable medium is defined herein as a non-transitory memory device. A memory device includes memory space within a single physical storage device or memory space spread across multiple physical storage devices.

Software instructions may be read into memory 830 and/or storage component 840 from another computer-readable medium or from another device via communication interface 870. When executed, software instructions stored in memory 830 and/or storage component 840 may cause processor 820 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

In embodiments, any one of the operations or processes of FIGS. 1 through 6 may be implemented by or using any one of the elements illustrated in FIGS. 7 and 8.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components or modules described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system for providing integrated utilities billing, the system comprising:
at least one memory storing instructions; and
at least one processor configured to execute the instructions to implement:
a customer relationship management (CRM) module configured to receive information from utilities providers for providing different types of utilities to at least one customer based on respective utilities plans, the CRM module comprising a database configured to store information associated with the at least one customer;
a product catalogue configured to store plan information regarding at least one utilities plan in association with each of the utilities providers;
a data collection module configured to receive raw data from a plurality of Internet of Things (IoT) sensors and to process the raw data to form processed data; and
a utilities rating and billing module configured to receive the processed data from the data collection module and the information associated with the at least one customer from the CRM module, and to generate a single invoice for the at least one customer based on the received processed data and on the received information,
wherein the generated single invoice comprises an invoice for each of the utilities providers providing utilities to the at least one customer.

2. The system of claim 1, wherein the at least one processor is further configured to execute the instructions to implement a provisioning module configured to receive information from the CRM module for activating or deactivating at least one from among the plurality of IoT sensors and to activate or deactivate the at least one from among the plurality of IoT sensors according to the received information.

3. The system of claim 1, wherein, for each customer of the at least one customer, the information associated with the customer comprises a customer identification (ID).

4. The system of claim 1, wherein, for each customer of the at least one customer, the information associated with the customer comprises a type of utility provided to the customer.

5. The system of claim 1, wherein:
the data collection module comprises a storage; and
the data collection module is further configured to store, in the storage of the data collection module, information regarding each IoT sensor from among the plurality of IoT sensors in association with the at least one customer.

6. The system of claim 1, wherein:
the at least one processor is further configured to execute the instructions to implement a collections and dunning processing module configured to receive collections information from the utility rating and billing module; and
the collections and dunning processing module is further configured to transmit deactivation information to the provisioning module to deactivate one or more IoT sensors from among the plurality of IoT sensors that are associated with a customer identified in the collections information.

7. The system of claim 1, wherein the information associated with the at least one customer comprises a mobile directory number (MDN) of the at least one customer selecting a utilities plan from a utilities provider from among the utilities providers, and
wherein the CRM module is configured to:
receive the plan information from the product catalogue;
determine whether the MDN of the at least one customer matches an MDN of customer information previously stored in the database of the order management module; and
provide the plan information to the utilities provider based on the determination.

8. The system of claim 7, wherein the CRM module is further configured to, based on the MDN of the at least one customer matching the MDN of customer information previously stored in the database:
determine a billing cycle associated with the customer information previously stored in the database;
select utilities plans from among the plan information that have billing cycles matching the billing cycle associated with the customer information previously stored in the database; and
provide information regarding the selected utilities plans to the utilities provider without providing information regarding other utilities plans included in the plan information.

9. The system of claim 8, wherein the CRM module is further configured to, based on the MDN of the at least one customer not matching the MDN of customer information previously stored in the database, provide information regarding all utilities plans included in the plan information to the utilities provider.

10. A method for providing information regarding one or more utilities plans stored in a product catalogue, the method comprising:
receiving information from utilities providers for providing different types of utilities to a customer based on respective utilities plans, and storing information associated with the customer in a database;
receiving raw data from a plurality of Internet of Things (IoT) sensors and processing the raw data to form processed data; and
based on the processed data and the information associated with the at least one customer, generating a single invoice for the customer.

11. The method of claim 10, further comprising:
determining a billing cycle associated with the customer information previously stored in the database;
selecting utilities plans from among the one or more utilities plans that have billing cycles matching the billing cycle associated with the customer information previously stored in the database; and
providing information regarding the selected utilities plans to at least one of the customer and a utilities provider without providing information regarding other utilities plans from among the one or more utilities plans.

12. The method of claim 11, further comprising, based on a mobile directory number (MDN) of the customer not matching the MDN of customer information previously stored in the database, providing information regarding all of the one or more utilities plans to the utilities provider.

13. A non-transitory computer-readable recording medium having recorded thereon instructions executable by at least one processor to perform a method for providing information regarding one or more utilities plans stored in a product catalogue, the method comprising:
receiving information from utilities providers for providing different types of utilities to a customer based on respective utilities plans, and storing information associated with the customer in a database;
receiving raw data from a plurality of Internet of Things (IoT) sensors and processing the raw data to form processed data; and
based on the processed data and the information associated with the at least one customer, generating a single invoice for the customer.
